(19) United States
(12) Patent Application Publication
(10) Pub. No.: US 2014/0149189 A1
(43) Pub. Date: May 29, 2014

(54) PRE-PAID TAXI SERVICE AND METHOD THEREFOR

(71) Applicant: Dave Gauer, Phoenix, AZ (US)

(72) Inventor: Dave Gauer, Phoenix, AZ (US)

(21) Appl. No.: 13/687,602

(22) Filed: Nov. 28, 2012

(51) Int. Cl. G07B 15/02

(52) U.S. Cl. CPC G07B 15/02
USPC 705/13

(57) ABSTRACT

A method of operating a prepaid taxi service comprising: purchasing a prepaid card, wherein the prepaid card has a removable section; calling a designated number associated with the prepaid card for taxi service, wherein the call is prioritized; verifying a unique identification number on the prepaid card; providing transportation for a party making the call; and providing the removable section to a taxi driver as payment.

### TECHNICAL FIELD

This application generally relates to transportation services, and, more particularly, to a prepaid taxi service wherein a customer calls a predetermined number for priority service. The customer then presents a coupon having a unique identification number to the taxi driver. After taking the customer to a desired location, the taxi driver will provide the identification number along with a meter receipt to a cashier for payment.

### BACKGROUND

When a person goes out, they often times forget to consider whether they will be consuming alcoholic beverages. Because of this, many people fail to take adequate precautions to avoid the possibility of driving while intoxicated. Some alternatives to driving while intoxicated include but are not limited to: choosing a designated driver; calling a friend; using public transportation; walking; or calling a taxi.

Unfortunately, each of the above alternatives has certain drawbacks. For example, a person may decide to go out alone. Thus, he/she may not be able to designate a person as a designated driver. Further, depending on how late a person is out, it may not be convenient to call a friend for a ride home. Public transportation in many cites do not run 24 hours a day. Also, it is difficult and time consuming to switch buses/subway lines especially late at night and if a person is slightly inebriated. Furthermore, public transportation will not take a person directly home but will drop a person off at a designated location meaning the person will have to walk a portion of the distance home. As stated above, if a person is too inebriated, walking all or part of the way home may not be possible.

Using a taxi service may be the most practical and convenient choice of the above. Unfortunately, to use a taxi service cannot only be a time consuming and expensive process but also requires the drinker to plan for and set aside the money necessary to pay for the service. When a person needs to catch a taxi, the person generally needs to search the street for an available taxi or call a taxi service and wait for the taxi to arrive. Depending on location this can be very time consuming. Furthermore, the portion of the fee that goes to pay the driver along with a tip can be costly.

Therefore, a need exists to provide a system and method to overcome the above issues.

### SUMMARY

A method of operating a prepaid taxi service comprising: purchasing a prepaid card, wherein the prepaid card has a removable section; calling a designated number associated with the prepaid card for taxi service, wherein the call is prioritized; verifying a unique identification number on the prepaid card; providing transportation for a party making the call; and providing the removable section to a taxi driver as payment.

A method of operating a prepaid taxi service comprising: purchasing a prepaid card, wherein the prepaid card has a removable section; calling a designated number associated with the prepaid card for taxi service, wherein the call is prioritized; obtaining information provided by a customer by a taxi company; verifying a unique identification number on the prepaid card; providing transportation for a party making the call; and providing the removable section to a taxi driver as payment.

A method of operating a prepaid taxi service comprising: purchasing a prepaid card, wherein the prepaid card has a removable section; calling a designated number associated with the prepaid card for taxi service, wherein the call is prioritized; verifying a unique identification number on the prepaid card; providing transportation for a party making the call; providing the removable section to a taxi driver as payment; preparing a receipt by the taxi driver; presenting the receipt and the removable section to a cashier for payment; verifying by the cashier the fare and distance traveled; and paying the taxi driver a verified fare.

The features, functions, and advantages can be achieved independently in various embodiments of the disclosure or may be combined in yet other embodiments.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a front view of a key chain attachment device used in the present invention;

FIG. 2 is a rear view of a key chain attachment device used in the present invention;

FIG. 3 is a front view of the key chain attachment device with the sticker portion removed;

FIG. 4 is a front view of a card containing the key chain attachment device; and

FIG. 5 is a front view of a receipt for use with the key chain attachment device.

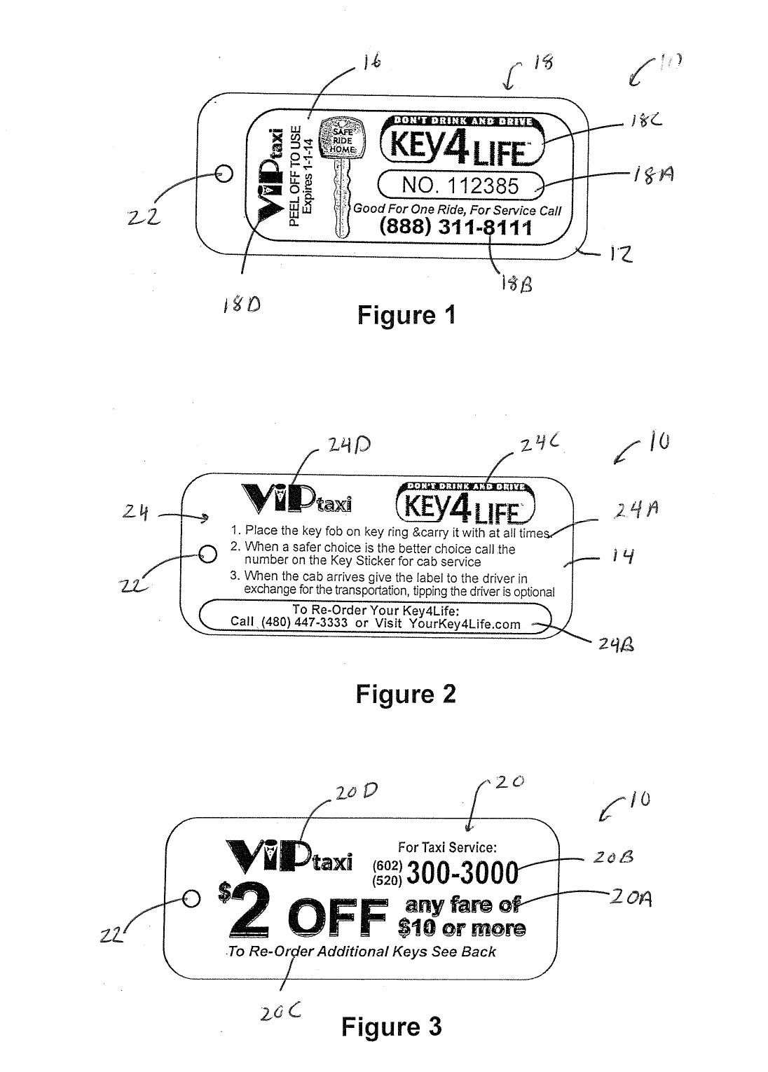

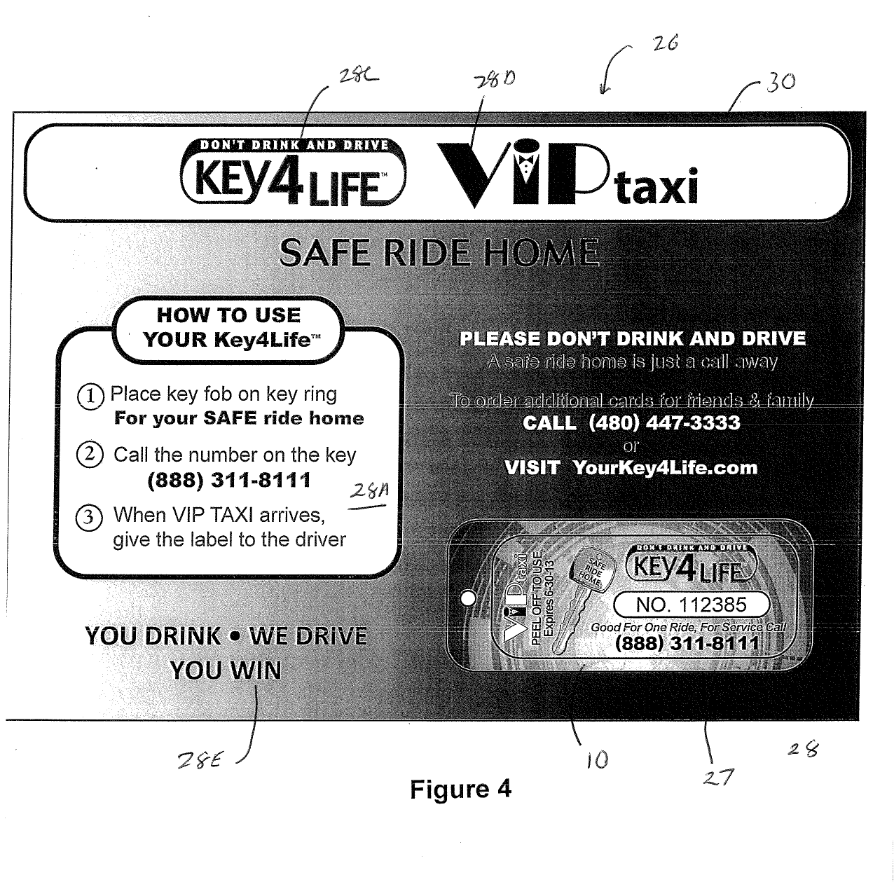

### DESCRIPTION OF THE APPLICATION

The description set forth below in connection with the appended drawings is intended as a description of presently preferred embodiments of the application and is not intended to represent the only forms in which the present application may be constructed and/or utilized. The description sets ^{forth} the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Referring now to the Figures, a prepaid taxi service device and method will be described. The prepaid taxi service device and method may have a key chain device 10. The key chain device 10 is similar in size to store loyalty card which may be placed on a key chain. Like the store loyalty card, the key chain device 10 may be made out of a lightweight but sturdy material such as plastic or the like. The listing of materials is given as an example and should not be seen in a limiting manner. While the Figures show the key chain device 10 as being rectangular in shape, the key chain device 10 may be formed in different shapes and sizes without departing from the spirit and scope of the present invention.

The key chain device 10 may have a first surface 12 and a second surface 14. The first surface 12 may have a section 16 having indicium 18 formed thereon. The indicium 18 may include but is not limited to: a unique identification number 18A, a telephone number 18B, company name 18C; taxi service name 18D; and an expiration date 18E. Other indicium may be included without departing from the spirit and scope of the present invention. Also, it should be noted that the taxi service may still honor the key chain device 10 even if the expiration date 18E has expired.

The section 16 having indicium 18 may be a removable from the key chain device 10. Thus, the section 16 may be a peelable label or the like. The section 16 may be formed of a vinyl material or similar material having properties may allow the section 16 to attach to the key chain device 10. Alternatively, an adhesive material may be used to allow the section 16 to attach to the key chain device 10.

Additional indicium 20 may be formed on the first surface 12 underneath the section 16. Once section 16 has been removed, the indicium 20 may be seen. The indicium 20 may include but is not limited to: a discount and or coupon 20A, telephone number(s) 20B for regular taxi service, re-order information 20C; taxi service name 20D. Other indicium 20 may be included without departing from the spirit and scope of the present invention.

The key chain device 10 may have an opening 22 fanned therein. The opening 22 may be formed along an outer perimeter of the key chain 10. The opening 22 is generally formed on the key chain 10 in an area not covered by the section 16. The opening 22 may be used to attach the key chain device 10 to a key chain.

The second surface 14 of the key chain device 10 may also have indicium 24. The indicium 24 on the second surface 14 of the key chain device 10 may include but is not limited to: directions 24A on how to use the key chain device 10 for free taxi service; reordering information 24B on how to obtain additional key chain devices 10; company name 24C; and taxi service name 24D.

The key chain device 10 may come on a card 26. Perforations 27 may be formed around a perimeter of the key chain device 10. The perforations 27 may allow one to remove the key chain device 10 from the card 26.

The card 26 may have indicium 28 on the surface 30 of the card 26. The indicium 28 may include but is not limited to: directions 28A on how to use the key chain device 10 for free taxi service; reordering information 28B on how to obtain additional key chain devices 10; company name 28C; taxi service name 28D; and drinking and driving text 28E.

In operation, a person would buy the key chain device 10 either separately, on a card 26 or the like. The key chain device 10 may be bought individually, in bulk such as a group of 5, or the like. The key chain device 10 may be purchased for a predetermined monetary value. In general, the monetary value may be based on an average fare/driving distance per taxi ride. The key chain device 10 may be sold in brick and motor stores, online, or by other means.

Once a key chain device 10 is purchased, in general, no activation is required. The key chain device 10 is ready for use. When a person goes out, and taxi service is required, a person may call the telephone number 18B located on the key chain device 10. The call center will ask the person for the unique identification number 18A, pick-up location, drop-off location, customer name, call back telephone number, and the like. The listing of the information is given as an example and should not be seen in a limiting manner. Once the information is obtained, the call will be prioritized and the first available/closest taxi to the location of the caller may be sent. Some of the above information may be written on the receipt 32 by the taxi driver. For example, the taxi driver may write down on the receipt 32: the pin-up location; the unique identification number 18A; the date, etc. It should be noted that a distance limit may form part of the present method. Thus, if a dispatcher confirms that a delivery distance exceeds a predetermine limit, the person may not be allowed to use the key chain device 10.

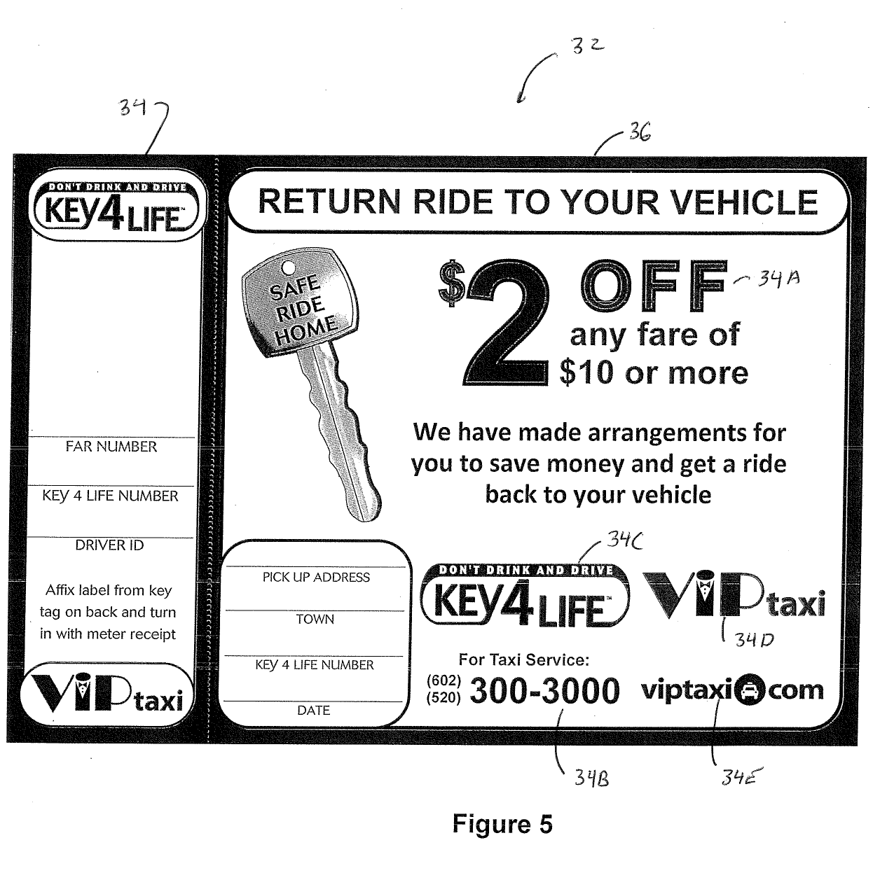

When the taxi arrives at the pick-up location, the taxi driver will pick-up the customer and asks the customer for the unique identification number 18A. The customer may then remove section 16 from the key chain device 10 and hand it to the taxi driver. The taxi driver may verify the unique identification number 18A with that given to the taxi driver. The taxi driver will then take the customer to the drop off location. The taxi driver may then fill in the receipt 32 shown in FIG. 5. The taxi driver may fill in the fare amount, the unique identification number 18A, and the taxi driver's identification number on the meter receipt portion 34 of the receipt 32. The taxi driver may also collect any tip the customer is willing to add. The taxi driver may then remove a coupon portion 36 from the receipt 32. The coupon portion 34 may have indicium 36 may include but is not limited to: discounts on fares 34A; telephone number for taxi service 34B; company name 34C; taxi service name 34D; taxi service website 34E; and the like. The above listing is given as an example and should not be seen in a limiting manner.

After the taxi driver may then combine the meter receipt portion 34 with the section 16 from the key chain device 10 and present this to a cashier at the taxi company for payment. The cashier may then look up the fare and compare the distance in a cab tracking software such as Cabmate to what was shown on the meter. If the amount is properly verified, the taxi driver will be paid the full verified fare as well as any tip. Abuse by the taxi driver may be caught during the verification process by the cashier. Abuse by a customer may be caught if a customer makes too many trips over a certain meter amount. That number of excessive trips may be determined based on the excess fare.

The use of the key chain device 10 may have certain guidelines to follow. For example, by accepting/using the key chain device 10, the customer would acknowledge certain rules and guidelines such as: (1) the program is designed to give another option when in need of a safe ride home. (2) the key chain device 10 is placed on the user's key ring, when out enjoying oneself at a public place, restaurant or bar that sells alcohol and either the customer or the customer's ride is impaired the key chain device 10 may be exchanged for a ride from a designated taxi service for up to two people to a single home or residence. (3) to get the full benefit of the program, the customer may need to: (A) Place the key fob on key ring and carry it with at all times; (B) when a safer choice is the better choice call the number on the key chain device 10 for taxi service; (C) when the taxi arrives give the section 16 to the driver in exchange for the transportation, tipping the driver is optional.

The key chain program 10 is not be used for ordinary taxi cab rides but to provide a safe way home from a public place, restaurant or bar that sells alcohol if the customer or a companion has been drinking and the person who would otherwise drive is impaired by drugs, intoxicated, or otherwise unable to drive.

While embodiments of the disclosure have been described in terms of various specific embodiments, those skilled in the art will recognize that the embodiments of the disclosure can be practiced with modifications within the spirit and scope of the claims.

What is claimed is:

1. A method of operating a prepaid taxi service comprising:
purchasing a prepaid card, wherein the prepaid card has a removable section;
calling a designated number associated with the prepaid card for taxi service, wherein the call is prioritized;
verifying a unique identification number on the prepaid card;
providing transportation for a party making the call; and
providing the removable section to a taxi driver as payment.

2. The method according to claim 1, further comprising:
preparing a receipt by the taxi driver;
presenting the receipt and the removable section to a cashier for payment;
verifying by the cashier the fare and distance traveled; and
paying the taxi driver a verified fare.

3. The method according to claim 1, further comprising verifying an expiration date on the prepaid card has not past.

4. The method according to claim 1, wherein providing transportation for a party making the call further comprises providing transportation for the party making the call from a public location to a residence only.

5. The method according to claim 1, confirming a location of transportation of the party is within a designated delivery limit.

6. The method according to claim 1, further comprising securing the prepaid card to a key chain of a user.

7. A method of operating a prepaid taxi service comprising:
purchasing a prepaid card, wherein the prepaid card has a removable section;
calling a designated number associated with the prepaid card for taxi service, wherein the call is prioritized;
obtaining information provided by a customer by a taxi company;
verifying a unique identification number on the prepaid card;
providing transportation for a party making the call; and
providing the removable section to a taxi driver as payment.

8. The method according to claim 7, wherein obtaining information provided by a customer by a taxi company further comprising:
obtaining a pick-up address of the customer;
obtaining a delivery address of the customer; and
obtaining the unique identification number on the prepaid card.

9. The method according to claim 8, further comprising confirming a location of transportation of the customer is within a designated delivery limit:

10. The method according to claim 7, further comprising
preparing a receipt by the taxi driver;
presenting the receipt and the removable section to a cashier for payment;
verifying by the cashier the fare and distance traveled; and
paying the taxi driver a verified fare.

11. The method according to claim 7, further comprising verifying an expiration date on the prepaid card has not past.

12. The method according to claim 7, wherein providing transportation for a party making the call further comprises providing transportation for a party making the call from a public location to a residence only.

13. The method according to claim 7, further comprising securing the prepaid card to a key chain of a user.

14. A method of operating a prepaid taxi service comprising:
purchasing a prepaid card, wherein the prepaid card has a removable section;
calling a designated number associated with the prepaid card for taxi service, wherein the call is prioritized;
verifying a unique identification number on the prepaid card;
providing transportation for a party making the call;
providing the removable section to a taxi driver as payment;
preparing a receipt by the taxi driver;
presenting the receipt and the removable section to a cashier for payment;
verifying by the cashier the fare and distance traveled; and
paying the taxi driver a verified fare.

15. The method according to claim 14, further comprising:
obtaining information provided by a customer by a taxi company, wherein the information comprises: obtaining a pick-up address of the customer; obtaining a delivery address of the customer; and obtaining the unique identification number on the prepaid card.

16. The method according to claim 15, further comprising confirming a location of transportation of the customer is within a designated delivery limit:

17. The method according to claim 14, further comprising verifying an expiration date on the prepaid card has not past.

18. The method according to claim 14, wherein providing transportation for a party making the call further comprises providing transportation for a party making the call from a public location to a residence only.

19. The method according to claim 14, further comprising securing the prepaid card to a key chain of a user.

20. A method of operating a prepaid taxi service comprising:
purchasing a prepaid device, wherein the prepaid device has a unique ID number;
calling a designated number associated with the prepaid device for taxi service, wherein the call is prioritized;
verifying the unique identification number on the prepaid device;
providing transportation for a party making the call; and
providing the prepaid device to a taxi driver as payment.
